(19) United States
(12) Patent Application Publication
(10) Pub. No.: US 2026/0035851 A1
(43) Pub. Date: Feb. 5, 2026

(54) WASHING MACHINE

(71) Applicant: SAMSUNG ELECTRONICS CO., LTD., Suwon-si (KR)

(72) Inventors: Hyunsoo PARK, Suwon-si (KR); Youngseong CHEON, Suwon-si (KR)

(73) Assignee: SAMSUNG ELECTRONICS CO., LTD., Suwon-si (KR)

(21) Appl. No.: 19/353,001

(22) Filed: Oct. 8, 2025

Related U.S. Application Data
(63) Continuation of application No. PCT/KR2024/002486, filed on Feb. 27, 2024.

(30) Foreign Application Priority Data
Apr. 26, 2023 (KR) 10-2023-0055036
Jul. 13, 2023 (KR) 10-2023-0091392

(51) Int. Cl. D06F 39/10; B01D 29/03; B01D 35/30; D06F 23/04; D06F 37/12

(52) U.S. Cl. CPC D06F 39/10; B01D 29/03; B01D 35/30; D06F 23/04; D06F 37/12; B01D 2201/40

(57) ABSTRACT

A washing machine includes a housing; a drum; and a filter. The filter includes a filter body including a first side portion having a first inlet and a second side portion having a second inlet. The filter includes a filter case that is coupled to the filter body and includes a first protruding rib to be coupleable to at least a portion of the first side portion and a second protruding rib to be coupleable to at least a portion of the second side portion. The at least a portion of the first side portion is disposed on the inner side of the first protruding rib. The at least a portion of the second side portion is disposed on the inner side of the second protruding rib.

### CROSS-REFERENCE TO RELATED APPLICATION

This application is a continuation application is a continuation application, under 35 U.S.C. § 111 (a), of international application No. PCT/KR2024/002486, filed Feb. 27, 2024, which claims priority under 35 U. S. C. § 119 to Korean Patent Application No. 10-2023-0055036, filed Apr. 26, 2023, and Korean Patent Application No. 10-2023-0091392, filed Jul. 13, 2023, the disclosures of which are incorporated herein by reference in their entireties.

### TECHNICAL FIELD

The disclosure relates to a washing machine including a filter.

### BACKGROUND ART

A washing machine is a device for performing washing by agitating laundry, water, and a detergent put into a washing chamber together using a driving force of a motor to wash the laundry by a mutual friction.

The washing machine includes a tub for storing water, a drum rotatably installed inside the tub, and a pulsator rotatably provided at the bottom of the drum.

When the drum and the pulsator rotate with laundry and water introduced into the drum, the pulsator agitates the laundry introduced into the drum together with the water, to remove dirt from the laundry.

### DISCLOSURE

### Technical Problem

One aspect of the disclosure provides a washing machine capable of filtering out and collect foreign substances contained in water.

One aspect of the disclosure provides a washing machine capable of improving water storage capacity.

One aspect of the disclosure provides a washing machine capable of preventing a filter from being detached from the drum.

The technical objectives of the disclosure are not limited to the above, and other objectives that are not described above will be clearly understood by those skilled in the art from the above detailed description.

### Technical Solution

A washing machine according to an aspect of the present disclosure may include a housing; a drum rotatably provided inside the housing; and a filter couplable to the drum. The filter includes a filter body including a first side portion having a first inlet portion formed thereon and a second side portion having a second inlet portion formed thereon and disposed opposite to the first side portion. The filter includes a filter case configured to be coupled to the filter body and including a first protruding rib configured coupleable to at least a portion of the first side portion and a second protruding rib configured coupleable to at least a portion of the second side portion. At least a portion of the first side portion is disposed on an inner side of the first protruding rib. A remaining portion of the first side portion, and the first protruding rib form an external appearance of the filter. At least a portion of the second side portion is disposed on an inner side of the second protruding rib. A remaining portion of the second side portion, and the second protruding rib form an external appearance of the filter.

A washing machine according to an aspect of the present disclosure may include: a housing; a drum rotatably provided inside the housing; a filter couplable to the drum and configured to filter out foreign substances. The filter includes a filter case couplable to the drum, and a filter body detachably mounted to the filter case and including an inlet portion and an outlet portion. The filter body includes a body protrusion protruding toward the filter case. The filter case includes a case protrusion protruding toward the body protrusion and a case groove recessed into the case protrusion to allow the body protrusion to be coupled thereto.

### Advantageous Effects

According to an aspect of the disclosure, foreign substances contained in water can be easily filtered out and collected.

According to an aspect of the disclosure, the water storage capacity of the washing machine can be improved.

According to an aspect of the disclosure, the filter can be prevented from being separated from the drum.

The effects of the disclosure are not limited to the effects described above, and other effects that are not described will be clearly understood by those skilled in the art from the above detailed description.

### DESCRIPTION OF DRAWINGS

FIG. 1 is a perspective view illustrating a washing machine according to an embodiment of the disclosure.

FIG. 2 is a cross-sectional view taken along line A-A′ of FIG. 1, showing main components of the washing machine according to an embodiment of the disclosure.

FIG. 3 is a perspective view illustrating a filter according to an embodiment of the disclosure.

FIG. 4 is a perspective view illustrating a filter according to an embodiment of the disclosure.

FIG. 5 is an exploded perspective view of components of the filter according to an embodiment of the disclosure.

FIG. 6 is an exploded perspective view of components of the filter according to an embodiment of the disclosure.

FIG. 7 is a longitudinal sectional view taken along line B-B″ of FIG. 2, showing main components of the washing machine according to an embodiment of the disclosure.

FIG. 8 is a perspective view illustrating a state in which in which the filter is separated from the drum according to an embodiment of the disclosure.

FIG. 9 is a perspective view illustrating a state in which components of the filter according to an embodiment of the disclosure are disassembled.

FIG. 10 is a perspective view illustrating a state in which components of the filter according to an embodiment of the disclosure are disassembled.

### MODES OF THE INVENTION

Various embodiments and the terms used therein are not intended to limit the technology disclosed herein to specific forms, and the disclosure should be understood to include various modifications, equivalents, and/or alternatives to the corresponding embodiments.

In describing the drawings, similar reference numerals may be used to designate similar constituent elements.

A singular expression may include a plural expression unless otherwise indicated herein or clearly contradicted by context.

The expressions “A or B,” “at least one of A or/and B,” or “one or more of A or/and B,” A, B or C,” “at least one of A, B or/and C,” or “one or more of A, B or/and C,” and the like used herein may include any and all combinations of one or more of the associated listed items.

The term of “and/or” includes a plurality of combinations of relevant items or any one item among a plurality of relevant items.

Herein, the expressions “a first”, “a second”, “the first”, “the second”, etc., may simply be used to distinguish an element from other elements, but is not limited to another aspect (e.g., importance or order) of elements.

When an element (e.g., a first element) is referred to as being “(functionally or communicatively) coupled,” or “connected” to another element (e.g., a second element), the first element may be connected to the second element, directly (e.g., wired), wirelessly, or through a third element.

In this disclosure, the terms “including”, “having”, and the like are used to specify features, numbers, steps, operations, elements, components, or combinations thereof, but do not preclude the presence or addition of one or more of the features, elements, steps, operations, elements, components, or combinations thereof.

When an element is said to be “connected”, “coupled”, “supported” or “contacted” with another element, this includes not only when elements are directly connected, coupled, supported or contacted, but also when elements are indirectly connected, coupled, supported or contacted through a third element.

Throughout the description, when an element is “on” another element, this includes not only when the element is in contact with the other element, but also when there is another element between the two elements.

A washing machine according to various embodiments may perform washing, rinsing, spin-drying, and drying processes. The washing machine is an example of a clothes care apparatus, and the clothes care apparatus is a concept including a device capable of washing clothes (objects to be washed, and objects to be dried), a device capable of drying clothes, and a device capable of washing and drying clothes.

The washing machine according to various embodiments may include a top-loading washing machine in which a laundry port for inserting or withdrawing laundry is provided to face upward, or a front-loading washing machine in which a laundry port is provided to face forward. The washing machine according to various embodiments may include a washing machine that is in a loading type other than the top-loading washing machine and the front-loading washing machine.

In the top-loading washing machine, laundry may be washed using water current generated by a rotating body such as a pulsator. In the front-loading washing machine, laundry may be washed by repeatedly lifting and lowering laundry by rotating a drum. The front-loading washing machine may include a dryer combined washing machine capable of drying laundry stored in a drum. The dryer combined washing machine may include a hot air supply device for supplying high-temperature air into the drum and a condensing device for removing moisture from air discharged from the drum. For example, the dryer combined washing machine may include a heat pump device. The washing machine according to various embodiments may include a washing machine using a washing method other than the above-described washing method.

The washing machine according to various embodiments may include a housing accommodating various components therein. The housing may be provided in the form of a box including a laundry port on one side thereof.

The washing machine may include a door for opening and closing the laundry port. The door may be rotatably mounted to the housing by a hinge. At least a portion of the door may be transparent or translucent to allow the inside of the housing to be seen.

The washing machine may include a tub disposed inside the housing to store water. The tub may be formed in a substantially cylindrical shape with a tub opening formed at one side thereof. The tub may be disposed inside the housing in such a way that the tub opening corresponds to the laundry port.

The tub may be connected to the housing by a damper. The damper may absorb vibration generated when the drum rotates, and the damper may reduce vibration transmitted to the housing.

The washing machine may include a drum provided to accommodate laundry.

The drum may be disposed inside the tub in such a way that a drum opening provided at one side of the drum corresponds to the laundry port and the tub opening. Laundry may pass through the laundry port, the tub opening, and the drum opening, sequentially and then be accommodated in the drum or withdrawn from the drum.

The drum may perform each operation according to washing, rinsing, and/or spin-drying while rotating inside the tub. A plurality of through holes may be formed in a cylindrical wall of the drum to allow water stored in the tub to be introduced into or to be discharged from the drum.

The washing machine may include a driving device configured to rotate the drum. The driving device may include a drive motor and a rotating shaft for transmitting a driving force generated by the drive motor to the drum. The rotating shaft may penetrate the tub to be connected to the drum.

The driving device may perform respective operations according to washing, rinsing, and/or spin-drying, or drying processes by rotating the drum in a forward or reverse direction.

The washing machine may include a water supply configured to supply water to the tub. The water supply may include a water supply pipe and a water supply valve disposed in the water supply pipe. The water supply pipe may be connected to an external water supply source. The water supply pipe may extend from an external water supply source to a detergent supply and/or the tub. Water may be supplied to the tub through the detergent supply. Alternatively, water may be supplied to the tub without passing through the detergent supply.

The water supply valve may open or close the water supply pipe in response to an electrical signal of a controller. The water supply valve may allow or block the supply of water to the tub from an external water supply source. The water supply valve may include a solenoid valve configured to open or close in response to an electrical signal.

The washing machine may include the detergent supply configured to supply detergent to the tub. The detergent supply may include a manual detergent supply that requires a user to input detergent to be used for each washing, and an automatic detergent supply that stores a large amount of detergent and automatically inputs a predetermined amount of detergent during washing. The detergent supply may include a detergent box for storing detergent. The detergent supply may be configured to supply detergent into the tub during a water supply process. Water supplied through the water supply pipe may be mixed with detergent via the detergent supply. Water mixed with detergent may be supplied into the tub. Detergent is used as a term including detergent for pre-washing, detergent for main washing, fabric softener, bleach, etc., and the detergent box may be partitioned into a storage region for the pre-washing detergent, a storage region for the main washing detergent, a storage region for the fabric softener, and a storage region for the bleach.

The washing machine may include a drain configured to discharge water contained in the tub to the outside. The drain may include a drain pipe extending from a bottom of the tub to the outside of the housing, a drain valve disposed on the drain pipe to open or close the drain pipe, and a pump disposed on the drain pipe. The pump may pump water from the drain pipe to the outside of the housing.

The washing machine may include a control panel disposed on one side of the housing. The control panel may provide a user interface for interaction between a user and the washing machine. The user interface may include at least one input interface and at least one output interface.

The at least one input interface may convert sensory information received from a user into an electrical signal.

The at least one input interface may include a power button, an operation button, a course selection dial (or a course selection button), and a washing/rinsing/spin-drying setting button. The at least one input interface may include a tact switch, a push switch, a slide switch, a toggle switch, a micro switch, a touch switch, a touch pad, a touch screen, a jog dial, and/or a microphone.

The at least one output interface may visually or audibly transmit information related to the operation of the washing machine to a user.

For example, the at least one output interface may transmit information related to a washing course, operation time of the washing machine, and washing/rinsing/spin-drying settings to the user. Information about the operation of the washing machine may be output through a screen, an indicator, or voice. The at least one output interface may include a Liquid Crystal Display (LCD) panel, a Light Emitting Diode (LED) panel, or a speaker.

The washing machine may include a communication module for wired and/or wireless communication with an external device.

The communication module may include at least one of a short-range wireless communication module and a long-range wireless communication module.

The communication module may transmit data to an external device (e.g., a server, a user device, and/or a home appliance) or receive data from the external device. For example, the communication module may establish communication with a server and/or a user device and/or a home appliance, and transmit and receive various types of data.

For the communication, the communication module may establish a direct (e.g., wired) communication channel or a wireless communication channel between external devices, and support the performance of the communication through the established communication channel. According to one embodiment, the communication module may include a wireless communication module (e.g., a cellular communication module, a short-range wireless communication module, or a global navigation satellite system (GNSS) communication module) or a wired communication module (e.g., a local area network (LAN) communication module, or a power line communication module). Among these communication modules, the corresponding communication module may communicate with an external device through a first network (e.g., a short-range wireless communication network such as Bluetooth, wireless fidelity (Wi-Fi) direct, or infrared data association (IrDA)) or a second network (e.g., a long-range wireless communication network such as a legacy cellular network, a 5G network, a next-generation communication network, the Internet, or a computer network (e.g., LAN or WAN). These various types of communication modules may be integrated as one component (e.g., a single chip) or implemented as a plurality of separate components (e.g., multiple chips).

The short-range wireless communication module may include a Bluetooth communication module, a Bluetooth Low Energy (BLE) communication module, a near field communication module, a WLAN (Wi-Fi) communication module, and a Zigbee communication module, an infrared data association (IrDA) communication module, a Wi-Fi Direct (WFD) communication module, an ultrawideband (UWB) communication module, an Ant+ communication module, a microwave (uWave) communication module, etc., but is not limited thereto.

The long-range wireless communication module may include a communication module that performs various types of long-range wireless communication, and may include a mobile communication circuitry. The mobile communication circuitry transmits and receives radio signals with at least one of a base station, an external terminal, and a server on a mobile communication network.

According to one embodiment, the communication module may communicate with an external device such as a server, a user device and other home appliances through an access point (AP). The access point (AP) may connect a local area network (LAN), to which a washing machine or a user device is connected, to a wide area network (WAN) to which a server is connected. The washing machine or the user device may be connected to the server through the wide area network (WAN). The controller may control various components of the washing machine (e.g., the drive motor, and the water supply valve). The controller may control various components of the washing machine to perform at least one operation including water supply, washing, rinsing, and/or spin-drying according to a user input. For example, the controller may control the drive motor to adjust the rotational speed of the drum or control the water supply valve of the water supply to supply water to the tub.

The controller may include hardware such as a CPU or memory, and software such as a control program. For example, the controller may include at least one memory for storing an algorithm and program-type data for controlling the operation of components in the washing machine, and at least one processor configured to perform the above-mentioned operation by using the data stored in the at least one memory. The memory and the processor may each be implemented as separate chips. The processor may include one or more processor chips or may include one or more processing cores. The memory may include one or more memory chips or one or more memory blocks. Alternatively, the memory and the processor may be implemented as a single chip.

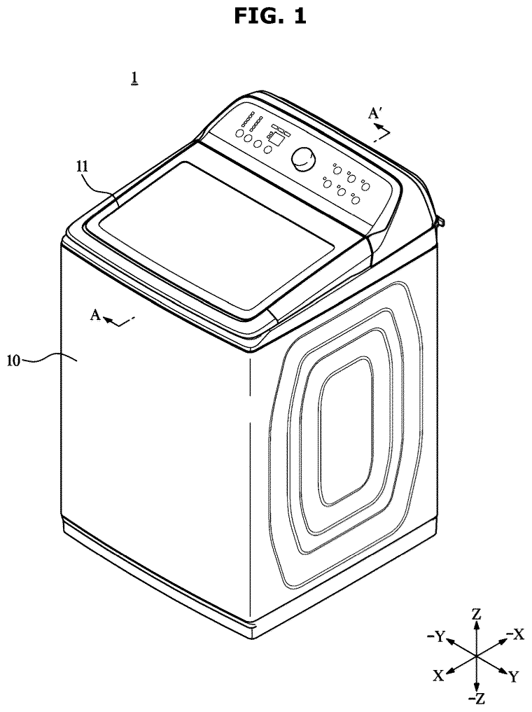

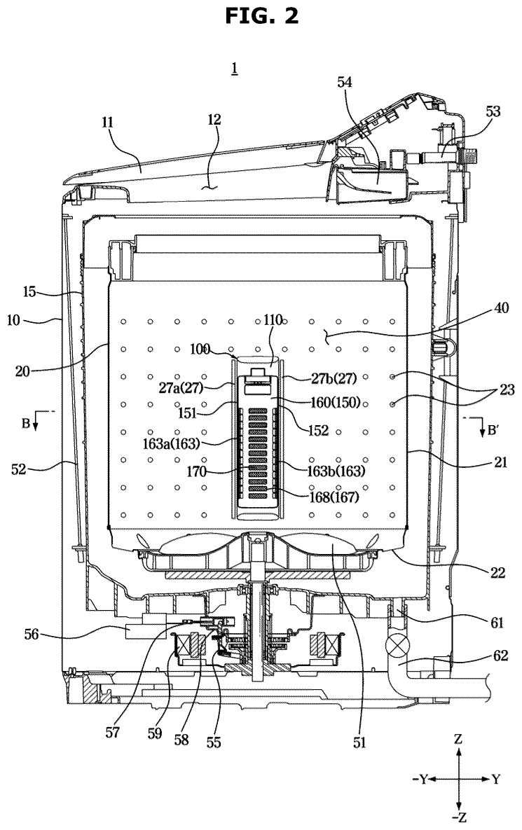

FIG. 1 is a perspective view illustrating a washing machine according to an embodiment of the disclosure. FIG. 2 is a cross-sectional view taken along line A-A′ of FIG. 1, showing main components of the washing machine according to an embodiment of the disclosure.

Meanwhile, for convenience, a portion in which a door 11 is disposed may be referred to as an upper part of a washing machine 1. Conversely, a portion adjacent to the ground may be referred to as a lower part of the washing machine 1. For example, referring to FIG. 2, the portion in which a laundry port 12 is disposed may be referred to as an upper part of the washing machine 1, and a portion in which a pulsator 51 is disposed may be referred to as a lower part of the washing machine 1.

The washing machine 1 may include a housing 10 forming the external appearance, a tub 15 disposed inside the housing 10 to store water, a drum 20 rotatably disposed inside the tub 15, and a pulsator 51 disposed inside the drum 20 to generate a water current.

The housing 10, which forms the external appearance of the washing machine, may be formed in a substantially rectangular parallelepiped shape. An upper part of the housing 10 may be formed with a laundry port 12 through which laundry is introduced into the drum 20. A door 11 for opening and closing the laundry port 12 may be provided on the upper side of the housing 10. The laundry port 12 may be opened and closed by the door 11.

The tub 15 may be vertically installed inside the housing 10. The tub 15 may be formed in a substantially hollow cylindrical shape having a bottom to accommodate such water. The tub 15 may be supported in the housing 10 by a suspension device 52.

The suspension device 52 may be provided to dampen vibrations generated from the tub 15. The upper part of the tub 15 may be provided with a water supply pipe 53 for supplying water to the tub 15. One side of the water supply pipe 53 may be connected to an external water source, and the other side of the water supply pipe 53 may be connected to a detergent supply device 54. Water supplied through the water supply pipe 53 may be supplied into the tub 15 together with detergent via the detergent supply device 54. A water supply valve may be installed in the water supply pipe 53 to control the supply of water.

The drum 20 may be formed in a substantially hollow cylindrical shape having a bottom. The drum 20 may be installed inside the tub 15. The drum 20 may be provided in a cylindrical shape with an open top.

The drum 20 may be provided on a side surface thereof with a plurality of dehydration holes 23. A balancer 30 may be mounted on an upper part of the drum 20 such that the drum may rotate stably during high-speed rotation.

The drum 20 may be provided to be rotatable inside the tub 15. The drum 20 may be disposed such that the central axis thereof coincides with the central axis of the tub 15.

The drum 20 may have a washing chamber 40 formed therein. The washing chamber 40 is provided to accommodate laundry.

The drum 20 may include a cylindrical portion 21 having a cylindrical shape, and a bowl portion 22 coupled to a lower part of the cylindrical portion 21. The cylindrical portion 21 may form a sidewall of the drum 20. The bowl portion 22 may form the bottom of the drum 20. The bowl portion 22 may be coupled to the cylindrical portion 21. The bowl portion 22 may have a substantially dish-like shape.

The pulsator 51 may be coupled to the lower part of the drum 20. The pulsator 51 may be coupled to the bowl portion 22. The pulsator 51 may be connected to the bowl portion 22.

The pulsator 51 may be rotatably installed at the lower part of the drum 20, and may agitate the laundry introduced into the drum 20 together with the water and generate a water current, such that the laundry in the drum 20 is washed by friction.

Outside the lower part of the tub 15, a motor 59 that generates a driving force for rotating the drum 20 and the pulsator 51, and a power switching device 55 that simultaneously or selectively transmits the driving force generated from the motor 59 to the drum 20 and the pulsator 51 may be installed.

The power switching device 55 may include an actuator 56 that generates a driving force for power switching, a rod portion 57 that moves linearly according to the operation of the actuator 56, and a clutch portion 58 that is connected to the rod portion 57 and rotates according to the operation of the rod portion 57.

A drain port 61 may be formed at the bottom of the tub 15 to discharge the water stored in the tub 15. The drain port 61 may be connected to a drain pipe 62.

The washing machine 1 may include a filter 100. The filter 100 may be disposed in the washing chamber 40. The filter 100 may be coupled to the drum 20. A method by which the filter 100 is coupled to the drum 20 will be described below.

The filter 100 may be provided to filter out foreign substances inside the washing chamber 40. The filter 100 may be provided to collect foreign substances contained in the water inside the washing chamber 40. For example, the filter may be provided to collect foreign substances floating in the water during the washing process, such as lint, hair, and animal fur. The filter may be provided to collect foreign substances to prevent constraint and leakage of the driving part of the washing machine 1 due to foreign substances.

In FIG. 2, a single filter 100 is illustrated as an example, but the disclosure is not limited thereto. Two or more filters 100 may be provided. For example, the filter 100 may include a first filter and a second filter spaced apart from the first filter.

The second filter may be disposed to face the first filter. However, the disclosure is not limited thereto. The arrangement of the first filter and the second filter may be provided in various ways.

The filter 100 may be disposed inside the drum 20. The filter 100 may be disposed at a lower inner side of the drum 20.

The filter 100 may be coupled to an inner wall of the drum 20. The filter 100 may be coupled to the cylindrical portion 21 of the drum 20.

The filter 100 may be installed spaced apart from the bowl portion 22 of the drum 20. The filter may be installed spaced apart from the pulsator 51.

By installing the filter 100 on the cylindrical portion 21 of the drum 20, the capacity reduction of the drum 20 may be minimized. Specifically, by installing the filter 100 at a position spaced apart from the bowl portion 22 of the drum 20, the degree of freedom in implementing the shape of the bowl portion 22 may be increased. Therefore, the water storage capacity of the drum 20 may be ensured.

The filter 100 may include an inlet portion 163 provided to allow the water to flow in. Through the inlet portion 163, the water and/or foreign substances inside the drum 20 may flow into the filter 100. The inlet portion 163 may be formed to allow foreign substances and water having a predetermined size or less to flow into a filter body 150. The inlet portion 163 may have at least one hole.

The inlet portions 163 may be disposed on side portions 151 and 152 of the filter 100. The inlet portion 163 may be provided such that water flows into the filter 100 by rotation of the drum 20 in the circumferential direction.

The inlet portion 163 may include a first inlet portion 163 facing a first rotational direction of the drum 20 and a second inlet portion 163b facing a second rotational direction, which is opposite to the first rotational direction of the drum 20. While the drum 20 rotates in the first rotational direction, water and/or foreign substances may flow in through the first inlet portion 163a. While the drum 20 rotates in the second rotational direction, water and/or foreign substances may flow in through the second inlet portion 163b.

The first inlet portion 163a and the second inlet portion 163b may be provided to face in opposite directions to each other. The first inlet portion 163a and the second inlet portion 163b may be arranged spaced apart along the circumferential direction of the drum 20.

The inlet portion 163 may be installed spaced upward from the bowl portion 22 and/or the pulsator 51 of the drum 20. The inlet portion 163 may be installed on the sidewall of the drum 20.

As the inlet portion 163 is disposed on the cylindrical portion 21 of the drum 20, a process of water being introduced into the filter 100 may be simplified. Without a separate driving device for introducing water into the filter 100, the water may be introduced into the filter 100 by the rotational water current generated during washing. In addition, a method by which the filter 100 collects foreign substances may be simplified.

In addition, the variation in the degree to which the filter 100 collects foreign substances according to the water level of the water may be reduced. Specifically, the variation in the degree to which the filter 100 collects foreign substances according to the amount of water current generated by the pulsator 51 may be reduced.

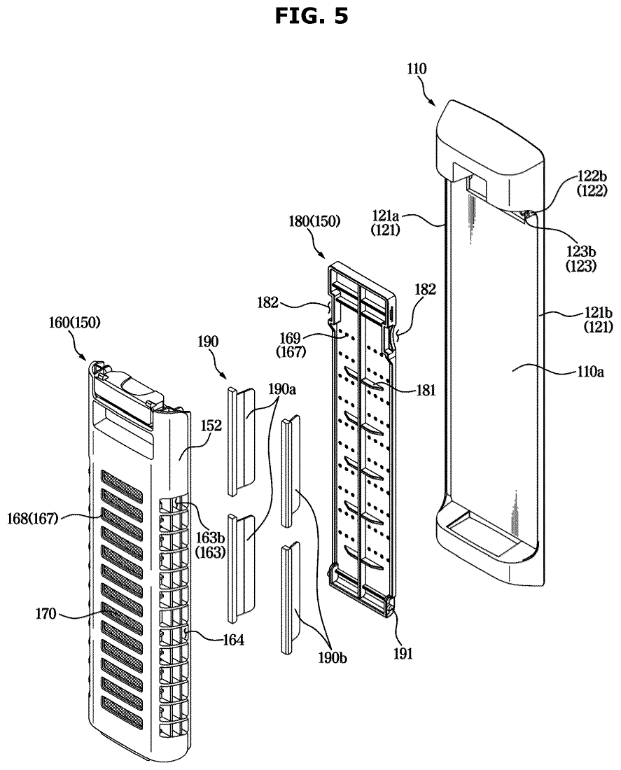

The filter 100 may include an outlet portion 167 provided to allow the water to be discharged. The outlet portion 167 may include a front outlet portion 168 and a rear outlet portion (169 in FIG. 5). The front outlet portion 168 may be disposed to face the rotation axis of the drum 20. The rear outlet portion 169 may be open in a direction opposite to the front outlet portion 168.

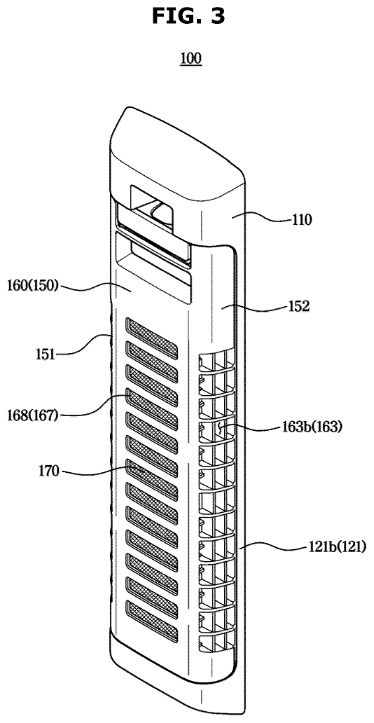

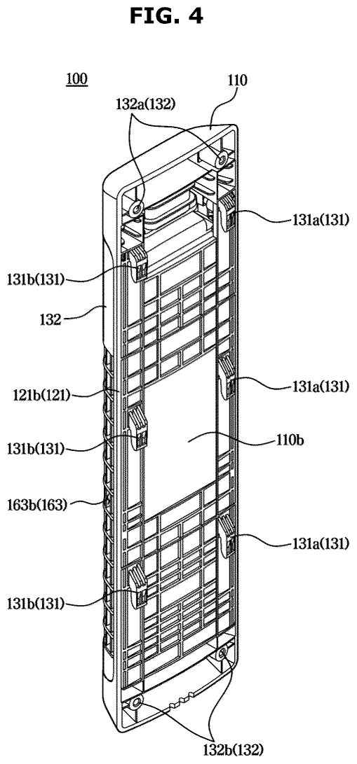

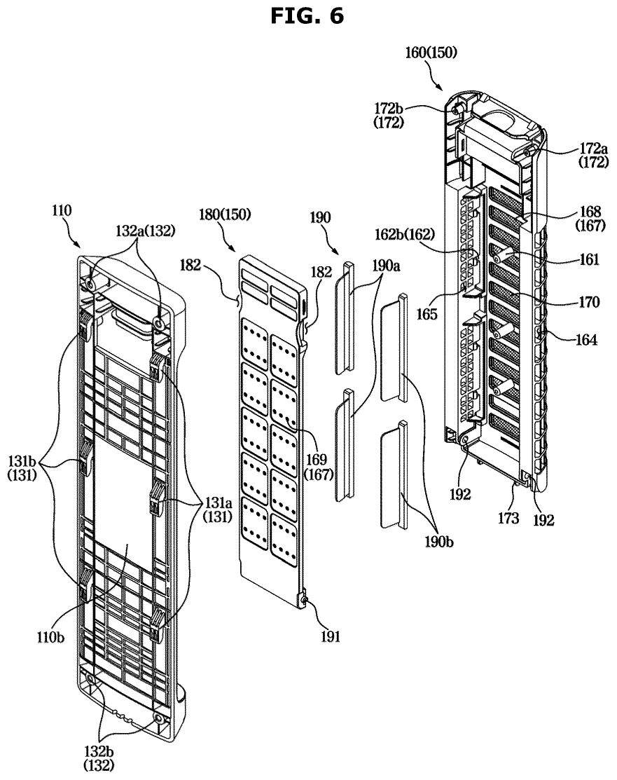

FIG. 3 is a perspective view illustrating a filter according to an embodiment of the disclosure. FIG. 4 is a perspective view illustrating a filter according to an embodiment of the disclosure. FIG. 5 is an exploded perspective view of components of the filter according to an embodiment of the disclosure. FIG. 6 is an exploded perspective view of components of the filter according to an embodiment of the disclosure.

The filter 100 may include a filter case 110 provided to be coupleable to the drum 20, a filter body 150 having an inlet portion 163 and an outlet portion 167, a check valve 190 disposed inside the filter body 150, and a mesh 170 provided to filter out foreign substances.

The filter 100 may include a filter body 150 coupleable to the filter case 110. The filter body 150 may include an inlet portion 163 provided to allow water and/or foreign substances to flow in, and an outlet portion 167 provided to allow water and/or foreign substances to be discharged.

The filter body 150 may include a front filter body 160 disposed at the front and a rear filter body 180 disposed at the rear of the front filter body 160. The front filter body 160 may be disposed to face the rotation axis of the drum 20. The rear filter body 180 may be disposed between the front filter body 160 and the filter case 110.

The filter body 150 may include an inlet portion 163. The inlet portion 163 may be provided on the filter body 150, which is detachable from the filter case 110. The inlet portion 163 may be provided on the front filter body 160.

By providing the inlet portion 163 on the filter body 150, even when laundry is caught in the inlet portion 163, the caught laundry may be easily removed by separating the filter body 150 from the filter case 110. That is, entanglement of laundry in the filter case 110 may be prevented. In addition, foreign substances caught in the inlet portion 163 may be easily handled.

The inlet portion 163 may include a first inlet portion 163a provided on a first side portion 151 of the filter body 150, and a second inlet portion 163b provided on a second side portion 152 disposed opposite the first side portion 151 of the filter body 150. The first inlet portion 163a and/or the second inlet portion 163b may have at least one hole.

The inlet portion 163 may include an outer inlet 164 and an inner inlet 165. The outer inlet 164 is provided on the outer side of the filter body 150, and the inner inlet 165 may be provided on the inner side of the filter body 150. The outer inlet 164 may be provided to pass through the outer surface of the filter body 150, and the inner inlet 165 may be provided to pass through the inner surface of the filter body 150.

The outer inlet 164 and the inner inlet 165 may be in communication. The water may flow into the filter 100 through the inner inlet 165 after passing through the outer inlet 164.

The first inlet portion 163a and the second inlet portion 163b may each include an outer inlet 164 and/or an inner inlet 165. The outer inlet 164 and/or the inner inlet 165 may have at least one hole.

The filter body 150 may include a partition rib 166. The outer inlet 164 and/or the inner inlet 165 may be partitioned by the partition rib 166.

The size of the outer inlet 164 and the size of the inner inlet 165 may be different from each other. The size of the inner inlet 165 may be provided to be smaller than the size of the outer inlet 164.

Since the inner inlet 165 is smaller than the outer inlet 164, laundry passing through the outer inlet 164 may not pass through the inner inlet 165. For example, buttons of clothes may be caught in the outer inlet 164 by the water current, but since the inner inlet 165 is formed small, may be prevented from being introduced into the filter 100. The inner inlet 165 may prevent laundry from being caught inside the filter 100.

The outer inlet 164 may be formed in a substantially trapezoidal shape. The inner inlet 165 may be formed in a substantially quadrangular shape. However, the disclosure is not limited thereto.

The outlet portion 167 may be provided to discharge the water that has been introduced into the filter 100 to the outside of the filter 100. The outlet portion 167 may be provided to filter the water that has being introduced through the inlet portion 163 and then discharge the filtered water back to the washing chamber 40. The outlet portion 167 may have at least one hole.

The outlet portion 167 may include a front outlet portion 168 and a rear outlet portion 169. The front outlet portion 168 may be disposed to face the rotation axis of the drum 20. The rear outlet portion 169 may be disposed to face in a direction opposite to the front outlet portion 168.

The outlet portion 167 may be provided with a mesh 170. The mesh 170 may be provided to filter out foreign substances from the water. The mesh 170 may have the shape of a net that filters out foreign substances. The mesh 170 may be provided corresponding in shape to the shape of the outlet portion 167.

The mesh 170 may be provided at each of the front outlet portion 168 and/or the rear outlet portion 169. Although the drawings illustrates, as an example, that the mesh 170 is provided only at the front outlet portion 168, but the disclosure is not limited thereto.

The front outlet portion 168 may be provided in the front filter body 160. The front outlet portion 168 may be disposed between the first inlet portion 163a and the second inlet portion 163b.

The front outlet portion 168 may be provided to discharge the water that has flowed into the filter 100 toward the inner side of the drum 20. The front outlet portion 168 may be provided such that the water is discharged toward the rotation axis of the drum.

The front outlet portion 168 may be provided in a substantially rectangular shape. The front outlet portion 168 may be formed to pass through the front filter body 160. The front outlet portion 168 may have at least one hole. The front outlet portions 168 may be arranged along the vertical direction.

The rear outlet portion 169 may be provided in the rear filter body 180. The rear outlet portion 169 may be provided to discharge the water that has flowed into the filter 100 toward the outer side of the drum 20. The rear outlet portion 169 may be opened in a direction opposite to the front outlet portion 168.

The rear outlet portion 169 may be provided in a substantially circular shape. The rear outlet portion 169 may be formed to pass through the rear filter body 180. The rear outlet portion 169 may have at least one hole.

The filter 100 may include a check valve 190. The check valve 190 may be provided to open the inlet portion 163. The opening refers to fully opening the inlet portion 163 or partially opening at least a portion of the inlet portion 163.

The check valve 190 may be provided to close the inlet portion 163. The closing refers to fully closing the inlet portion 163 or partially closing at least a portion of the inlet portion 163. For example, the closing may refers to completely sealing or partially closing the inlet portion 163 to reduce a flow rate of water and/or foreign substances flowing into the inlet portion 163.

The check valve 190 may be provided as an elastic body. The check valve 190 may be provided to be deformable by a force exerted by the water and/or foreign substances while the drum 20 rotates.

The check valve 190 may open or close the inlet portion 163 to allow foreign substances to flow into a chamber C, but prevent the foreign substances from being discharged from the chamber. The check valve 190 may be provided to open or close the inlet portion 163 depending on the direction of the water current.

The check valve 190 may open the inlet portion 163 in a direction in which water and/or foreign substances flow in through the inlet portion 163. The check valve 190 may close the inlet portion 163 in a direction in which water and/or foreign substances are discharged through the inlet portion 163.

The check valve 190 may include a first check valve 190a provided to open or close the first inlet portion 163a and a second check valve 190b provided to open or close the second inlet portion 163b.

The check valve 190 may be disposed inside the filter body 150. The check valve 190 may be disposed in the chamber C.

The check valve 190 may be coupled to the front filter body 160. The front filter body 160 may include a check valve coupling portion 162 provided for the check valve 190 to be coupled thereto. The check valve coupling portion 162 may include a protrusion provided to contact and fix the check valve 190. The check valve coupling portion 162 may be provided on the inner side of the filter body 150.

The check valve 190 may include a first check valve 190a provided to open or close the first inlet portion 163a, and a second check valve 190b provided to open or close the second inlet portion 163b. The first check valve 190a and/or the second check valve 190b may each be provided in plurality. The plurality of first check valves 190a and/or the second check valves 190b may be arranged along the vertical direction.

The check valve coupling portion 162 may include a first check valve coupling portion 162a provided for the first check valve 190a to be coupled thereto, and a second check valve coupling portion 162b provided for the second check valve 190b to be coupled thereto. The first check valve coupling portion 162a may be disposed between the main outlet portion 167 and the first inlet portion 163a. The second check valve coupling portion 162b may be disposed between the main outlet portion 167 and the second inlet portion 163b.

The front filter body 160 may include a collecting protrusion 161 provided to collect foreign substances that have flowed into the filter 100. The collecting protrusion 161 may be provided around the front outlet portion 168. The collecting protrusion 161 may be in the form of a protrusion that protrudes toward the rear filter body 180.

The rear filter body 180 may include a collecting rib 181 provided to collect foreign substances that have flowed into the filter 100. The collecting rib 181 may be provided around the rear outlet portion 169. The collecting rib 181 may be a rib that protrudes toward the front filter body 160.

Foreign substances that have flowed into the filter 100 may be collected inside the filter 100 by being wound around the collecting protrusion 161 and/or the collecting rib 181. For example, foreign substances such as hair and animal fur may be easily collected by the collecting protrusion 161 and/or the collecting rib 181.

The filter body 150 may be provided to be coupled with the filter case 110. The filter body 150 may include a body coupling portion provided to be coupleable with the filter case 110.

The body coupling portion may include a body protrusion 172. The body protrusion 172 may be a protrusion that protrudes from the filter body 150 toward the filter case 110. The body protrusion 172 may be a protrusion that protrudes rearward from the filter body 150.

The body protrusion 172 may include a first body protrusion 172a and a second body protrusion 172b spaced apart from the first body protrusion 172a. The first body protrusion 172a is provided on the first side portion 151 of the filter body 150, and the second body protrusion 172b may be provided on the second side portion 152 of the filter body 150.

The body protrusion 172 may be provided on the front filter body 160. The body protrusion 172 may be formed on an upper part of the front filter body 160. The body protrusion 172 may be coupled to a case groove 123 of the filter case 110. This will be described below.

The body coupling portion may include a guide protrusion 173. The guide protrusion 173 may be formed on a lower part of the front filter body 160. The guide protrusion 173 may be coupled to a guide hole 125 of the filter case 110. This will be described below.

The front filter body 160 and the rear filter body 180 may be coupled to each other. The rear filter body 180 may include a hinge protrusion 191. The front filter body 160 may include a hinge groove 192 corresponding to the hinge protrusion 191. The front filter body 160 and the rear filter body 180 may be hinge-coupled. The rear filter body 180 may be coupled to be pivotable with respect to the front filter body 160.

The filter 100 may include a filter case 110. The filter case 110 may be provided such that the filter 100 is coupleable to the drum 20. The filter case 110 may include a filter case rear surface 110b disposed to face an inner wall of the drum 20, and a filter case front surface 110a disposed opposite to the filter case rear surface 110b.

The filter case 110 may be provided to be coupleable with the filter body 150. The filter case 110 may include a front coupling portion provided to be coupled with the filter body 150.

The front coupling portion may include a case protrusion 122 disposed on the filter case front surface 110a. The case protrusion 122 may be formed to protrude from the filter case front surface 110a toward the filter body 150. The case protrusion 122 may have a cylindrical shape.

The front coupling portion may include a case groove 123. The case groove 123 may be a recessed portion of the case protrusion 122. The case groove 123 may be a groove formed in the case protrusion 122.

The case protrusion 122 may include a first case protrusion 122a and a second case protrusion 122b spaced apart from the first case protrusion 122a. The case groove 123 may include a first case groove 123a provided in the first case protrusion 122a and a second case groove 123b provided in the second case protrusion 122b. The first case groove 123a may be provided to be coupleable with the first body protrusion 172a, and the second case groove 123b may be provided to be coupleable with the second body protrusion 172b.

The body protrusion 172 and the case groove 123 may be coupled to each other with an implant structure. The body protrusion 172 may be easily inserted into the case groove 123 formed in the case protrusion 122, and after insertion, may be fixed such that the coupling is not released.

By being inserted into the case groove 123, the body protrusion 172 may prevent the filter body 150 from moving left and right due to the rotational water current. In addition, the body protrusion 172 may prevent the filter body 150 from detaching from the filter case 110.

The front coupling portion may include a guide hole 125. The guide hole 125 may be disposed at a lower portion of the filter case 110. The guide hole 125 may be disposed below the case groove 123. The guide hole 125 may be formed to pass through the lower portion of the filter case 110.

The guide hole 125 of the filter case 110 may correspond to the guide protrusion 173 of the filter body 150. The guide protrusion 173 of the filter body 150 may be inserted into the guide hole 125 of the filter case 110.

By being inserted into the guide hole 125, the guide protrusion 173 may guide the coupling position of the filter body 150 such that the filter body 150 is easily coupled to the filter case 110.

The front coupling portion may include a protruding rib 121. The protruding rib 121 may be provided to prevent the filter body 150 from moving. The protruding rib 121 may be provided to support the filter body 150 that is coupled to the filter case 110. The protruding rib 121 may be provided to prevent the filter body 150 from detaching from the filter case 110.

The protruding rib 121 may be formed on the filter case front surface 110a. The protruding rib 121 may protrude from the filter case front surface 110a toward the filter body 150.

The protruding rib 121 may be disposed on both side portions of the filter case 110. The protruding rib 121 may form a border of the filter case front surface 110a. The protruding rib 121 may extend in the vertical direction.

The protruding rib 121 may form the external appearance of the filter 100. The protruding rib 121 may be disposed to form the external appearance of the filter 100 together with the filter body 150.

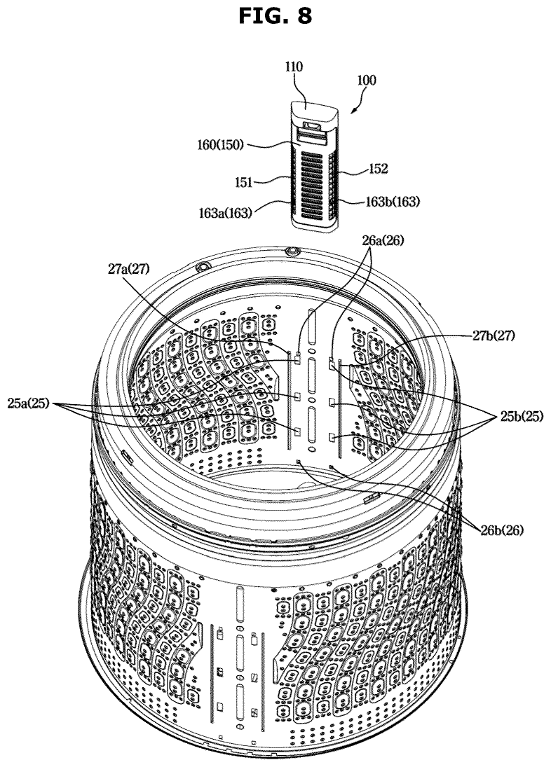

The protruding rib 121 may include a first protruding rib 121a provided to support at least a portion of the first side portion 151 of the filter body 150 and a second protruding rib 121b provided to support at least a portion of the second side portion 152 of the filter body 150. This will be described below with reference to FIG. 8.

A rear coupling portion may be formed on the filter case rear surface 110b. The rear coupling portion may be provided such that the filter case 110 is coupled to the drum 20.

The rear coupling portion may include a coupling hook 131. The coupling hook 131 may have a hook shape protruding from the filter case rear surface 110b. The coupling hook 131 may be fastened to a hook hole 25 formed in the cylindrical portion 21 of the drum 20. This will be described below.

The coupling hook 131 may include a first coupling hook 131a and a second coupling hook 131b provided on both side portions of the filter case rear surface 110b. The first coupling hook 131a and the second coupling hook 131b may be provided at symmetrical positions. The first coupling hook 131a and/or the second coupling hook 131b may each be provided in plurality.

Although the drawing illustrates that the first coupling hooks 131a arranged in the vertical direction are provided in three units, and the second coupling hook 131b arranged in the vertical direction are provided in three units, but the disclosure is not limited thereto. The number of coupling hooks may be variously implemented.

The rear coupling portion may include a screw fastening portion 132. The screw fastening portion 132 may correspond to a screw hole 26 formed in the cylindrical portion 21 of the drum 20. The filter case 110 may be coupled to the drum 20 by a screw being fastened to the screw fastening portion 132 and the screw hole 26. This will be described below.

The screw fastening portion 132 may include a first screw fastening portion 132a disposed at an upper portion of the filter case rear surface 110b, and a second screw fastening portion 132b disposed at a lower portion of the filter case rear surface 110b. The first screw fastening portion 132a and/or the second screw fastening portion 132b may each be provided in plurality.

Although the drawing illustrates that the first screw fastening portions 132a arranged in the left-right direction are provided in two units, and the second screw fastening portions 132b arranged in the left-right direction are provided in two units, the disclosure is not limited thereto. The number of screw fastening portions may be variously implemented.

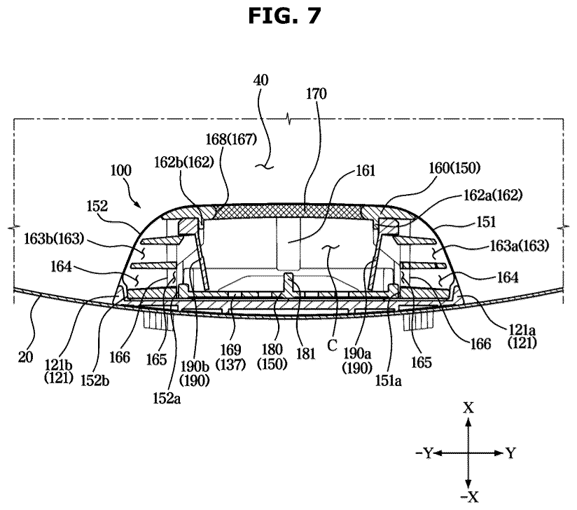

FIG. 7 is a longitudinal sectional view taken along line B-B″ of FIG. 2, showing main components of the washing machine according to an embodiment of the disclosure.

The filter 100 may include a chamber C for collecting foreign substances. The chamber C may be a space formed inside the filter body 150. The chamber C may be formed on the inner side of the filter body 150.

When the drum 20 rotates in a first rotational direction and the rotational water current is introduced into the first inlet portion 163a, the first check valve 190a may be pushed toward the inside of the filter 100 by the water pressure of the rotational water current to open the first inlet portion 163a. On the other hand, the second check valve 190b may be pushed toward the outside of the filter 100 by the water pressure of the rotational water current to close the second inlet portion 163b. That is, since the first inlet portion 163a is opened and the second inlet portion 163b is closed, the water that has been introduced into the filter 100 through the first inlet portion 163a may be prevented from being discharged through the second inlet portion 163b.

Conversely, when the drum rotates in a second rotational direction and the rotational water current flows into the second inlet portion 163b, the second check valve 190b may be pushed toward the inside of the filter 100 by the water pressure of the rotational water current to open the second inlet portion 163b. On the other hand, the first check valve 190a may be pushed toward the outside of the filter 100 by the water pressure of the rotational water current to close the first inlet portion 163a. That is, since the second inlet portion 163b is open and the first inlet portion 163a is closed, the water that has been introduced into the filter 100 through the second inlet portion 163b may be prevented from being discharged through the first inlet portion 163a.

The water introduced through the first inlet portion 163a and/or the second inlet portion 163b may be filtered by the mesh 170 to remove foreign substances, and the water with the foreign substances filtered out may be discharged to the outside of the filter 100 through the outlet portion 167. The foreign substances may be collected inside the chamber C.

When the drum 20 rotates in the first rotational direction, the filter body 150 may be pressed in the first rotational direction by the rotational water current. The first protruding rib 121a of the filter case 110 may be provided to support the first side portion 151 of the filter body 150 in the second rotational direction when the drum 20 rotates in the first rotational direction. The first protruding rib 121a, by supporting the filter body 150 in the second rotational direction, may prevent the filter body 150 from moving in the first rotational direction.

When the drum 20 rotates in the second rotational direction, the filter body 150 may be pressed in the second rotational direction by the rotational water current. The second protruding rib 121b of the filter case 110 may be provided to support the second side portion 152 of the filter body 150 in the first rotational direction when the drum 20 rotates in the second rotational direction. The second protruding rib 121b, by supporting the filter body 150 in the first rotational direction, may prevent the filter body 150 from moving in the second rotational direction.

The protruding rib 121 may be disposed on the outside of the filter body 150. The protruding rib 121 may be disposed to support the outside of the filter body 150.

When the filter body 150 is coupled to the filter case 110, at least a portion of the filter body 150 may be disposed on the inner side of the protruding rib 121. At least a portion of the first side portion 151 of the filter body 150 may be disposed on the inner side of the first protruding rib 121a. At least a portion of the second side portion 152 of the filter body 150 may be disposed on the inner side of the second protruding rib 121b.

The remaining portion of the first side portion 151 of the filter body 150 may form the external appearance of the filter 100 together with the first protruding rib 121a. The remaining portion of the second side portion 152 of the filter body 150 may form the external appearance of the filter 100 together with the second protruding rib 121b.

The first side portion 151 of the filter body 150 may include a first inner surface 151a disposed to face the chamber C and a first outer surface 151b disposed opposite to the first inner surface 151a. The first inner surface 151a may be disposed on the inner side of the filter body 150, and the first outer surface 151b may be disposed on the outer side of the filter body 150.

The first protruding rib 121a may be disposed to be in contact with the first outer surface 151b of the first side portion 151. The first protruding rib 121a may be provided to support the first outer surface 151b in the second rotational direction.

The second side portion 152 of the filter body 150 may include a second inner surface 152a disposed to face the chamber C and a second outer surface 152b disposed opposite to the second inner surface 152a. The second inner surface 152a may be disposed on the inner side of the filter body 150, and the second outer surface 152b may be disposed on the outer side of the filter body 150.

The second protruding rib 121b may be disposed to be in contact with the second outer surface 152b of the second side portion 152. The second protruding rib 121b may be provided to support the second outer surface 152b in the first rotational direction.

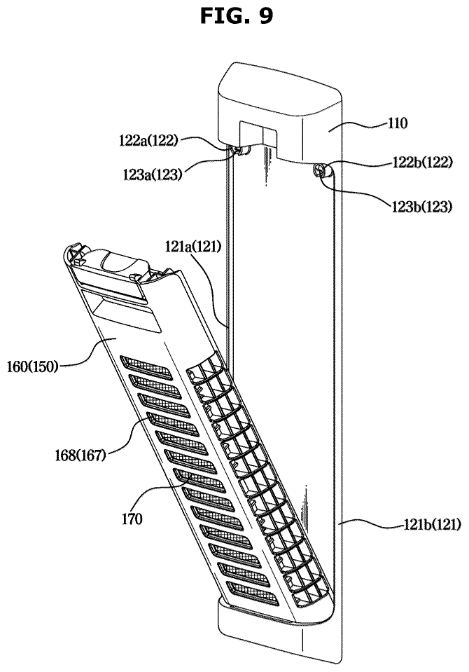

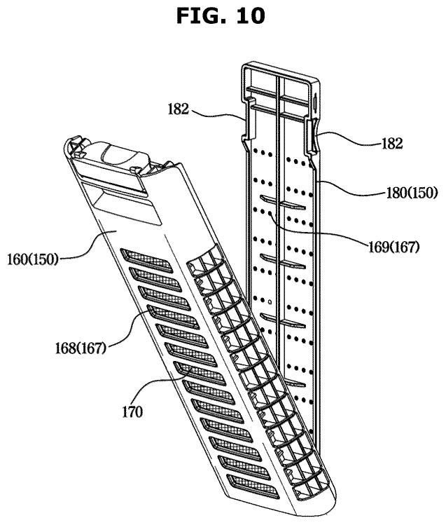

FIG. 8 is a perspective view illustrating a state in which in which the filter is separated from the drum according to an embodiment of the disclosure. FIG. 9 is a perspective view illustrating a state in which components of the filter according to an embodiment of the disclosure are disassembled. FIG. 10 is a perspective view illustrating a state in which components of the filter according to an embodiment of the disclosure are disassembled.

Referring to FIG. 8, the filter 100 may be coupled to and/or detached from the drum 20. The drum 20 may include a drum coupling portion provided for the filter case 110 to be coupleable. The drum coupling portion may be provided on the cylindrical portion 21 of the drum 20.

The drum coupling portion may include a hook hole 25. The hook hole 25 may be provided to correspond to the coupling hook 131 of the filter case 110. The hook hole 25 may include a first hook hole 25a and a second hook hole 25b provided on both side portions. The first hook hole 25a and/or the second hook hole 25b may each be provided in plurality.

The drum coupling portion may include a screw hole 26. The screw hole 26 may be provided to correspond to the screw fastening portion 132 of the filter case 110. The screw hole 26 may include a first screw hole 26a corresponding to the first screw fastening portion 132a and a second screw hole 26b corresponding to the second screw fastening portion 132b.

Meanwhile, the drum 20 may include an inner wall rib 27. The inner wall rib 27 may be provided on the cylindrical portion 21. The inner wall rib 27 may be formed protruding from the inner wall of the drum 20.

The inner wall ribs 27 may be formed at both sides of a position in which the filter 100 is coupled. The inner wall rib 27 may include a first inner wall rib 27a and a second inner wall rib 27b formed at both sides of the filter 100. The first inner wall rib 27a may be disposed around the first inlet portion 163a of the filter 100, and the second inner wall rib 27b may be disposed around the second inlet portion 163b of the filter 100.

The inner wall rib 27 may serve as a stopper to prevent laundry from being introduced into the inlet portion 163 of the filter 100 while the laundry rotates with the water current. The first inner wall rib 27a may prevent laundry from being caught in the first inlet portion 163a, and the second inner wall rib 27b may prevent laundry from being caught in the second inlet portion 163b.

Meanwhile, the user may separate the filter 100 from the drum 20 for periodic cleaning or replacement of the filter 100.

Referring to FIG. 9, after the filter 100 is separated from the drum 20, the filter body 150 may be separated from the filter case 110.

Referring to FIG. 10, after separating the filter body 150 from the filter case 110, the filter body 150 may be opened. That is, coupling of the front filter body 160 and the rear filter body 180 may be partially released.

In this case, by pressing a recess 182 formed on the rear filter body 180, the rear filter body 180 may be easily opened from the front filter body 160.

The recess 182 of the rear filter body 180 may be formed on the upper portion of the rear filter body 180. The recess 182 may include a shape that is concavely indented toward the inside.

Since the lower portion of the rear filter body 180 is hinge-coupled to the front filter body 160, pressing the recess 182 formed on the upper part may allow the rear filter body 180 to rotate from the front filter body 160 and open the inside of the filter 100. Afterwards, the foreign substances collected inside the filter 100 may be removed.

By installing the filter 100 in the washing machine 1, the performance of removing foreign substances from the water may be improved. Specifically, when compared to a case without the filter 100, the collection performance of foreign substances may be improved by about 5 times or more. However, the disclosure is not limited thereto.

A washing machine 1 according to an embodiment of the present disclosure may include: a housing 10; a drum 20 rotatably provided inside the housing 10; and a filter 100 couplable to the drum 20, wherein the filter 100 includes: a filter body 150 including a first side portion 151 having a first inlet portion 163a formed thereon and a second side portion 152 having a second inlet portion 163b formed thereon and disposed opposite to the first side portion 151; and a filter case 110 configured to be coupled to the filter body 150 and including a first protruding rib 121a configured to support at least a portion of the first side portion 151 and a second protruding rib 121b configured to support at least a portion of the second side portion 152, wherein at least a portion of the first side portion 151 is disposed on an inner side of the first protruding rib 121a, and a remaining portion of the first side portion 151 and the first protruding rib 121a form an external appearance of the filter 100, and at least a portion of the second side portion 152 is disposed on an inner side of the second protruding rib 121b, and a remaining portion of the second side portion 152a and the second protruding rib 121b form an external appearance of the filter 100. According to the present disclosure, even when the drum 20 rotates, separation of the filter body 150 from the filter case 110 can be prevented.

The filter body may further include a chamber formed inside thereof to collect foreign substances, and the first protruding rib and the second protruding rib may be disposed on an outer side of the filter body. According to the present disclosure, by supporting an outer side of the filter body 150, the protruding ribs 121 may prevent the filter body 150 from being displaced depending on a first or second rotational direction of the drum 20.

The first side portion of the filter body may include an inner surface disposed to face the chamber and an outer surface disposed opposite to the inner surface, and the first protruding rib may be disposed to contact the outer surface of the first side portion. According to the present disclosure, the protruding rib 121a) can support the filter body 150 more firmly by contacting an outer surface 151b) of the first side portion 151.

The filter body may further include a body protrusion protruding toward the filter case, and the filter case may further include a case groove configured to be coupleable with the body protrusion. According to the present disclosure, separation of the filter body 150 from the filter case 110 can be prevented.

The filter case may further include a case protrusion protruding toward the filter body, and the case groove may be formed to be recessed in the case protrusion. According to the present disclosure, the filter body 150 can be easily coupled to the filter case 110, and separation of the filter body 150 from the filter case 110 can be prevented

The body protrusion may include a first body protrusion provided on the first side portion of the filter body and a second body protrusion provided on the second side portion of the filter body, and the case groove may include a first case groove configured to be coupleable with the first body protrusion and a second case groove configured to be coupleable with the second body protrusion. According to the present disclosure, even when the drum 20 rotates in the first rotational direction or in the second rotational direction, lateral displacement of the filter body 150 can be prevented.

The case groove may be disposed between the first protruding rib and the second protruding rib. According to the present disclosure, the protruding rib 121 and the case groove 123 can firmly couple the filter body 150 to the filter case 110

The filter body may further include: a front filter body in which the first inlet portion and the second inlet portion are formed thereon; and a rear filter body disposed between the front filter body and the filter case, wherein the body protrusion may be provided on the front filter body. According to the present disclosure, the front filter body 160 can be firmly coupled to the filter case 110.

The front filter body and the rear filter body may be hinged-coupled to each other. According to the present disclosure, the rear filter body 180 can be rotated from the front filter body.

The filter body may include: a front outlet portion formed to pass through the front filter body; and a rear outlet portion formed to pass through the rear filter body and open in a direction opposite to the front outlet portion. According to the present disclosure, the filter 100 can discharge water and/or foreign substances in both directions.

The rear filter body may include a collection rib configured to collect foreign substances introduced into the filter body, the collection rib protruding toward the front filter body. According to the present disclosure, foreign substances introduced into the filter 100 can be wound around the collection rib 181, thereby improving performance of collecting the foreign substances

The drum may include: a cylindrical portion having a cylindrical shape; and a bowl portion coupled to a lower portion of the cylindrical portion to form a bottom of the drum; wherein the filter case may be disposed spaced apart from the bowl portion. According to the present disclosure, since the shape of the bowl portion 22 is freely implemented, a water storage capacity of the drum 20 can be ensured

The drum may further include an inner wall rib spaced apart from the filter case and protruding from the cylindrical portion toward a rotation axis of the drum. The inner wall rib may include a first inner wall rib and a second inner wall rib spaced apart from the first inner wall rib. According to the present disclosure, laundry being caught in the inlet portion 163 of the filter 100 can be prevented.

The first inlet portion may include: an outer inlet provided on an outer side of the filter body; and an inner inlet configured to communicate with the outer inlet and provided on an inner side of the filter body; wherein a size of the inner inlet may be provided smaller than a size of the outer inlet. According to the present disclosure, laundry can be prevented from being introduced into the filter 100.

The inlet portion 163 may include a first inlet portion 163a) formed at the first side portion 151 of the filter body 150 and a second inlet portion 163b) formed at the second side portion 152 of the filter body 150. According to the present disclosure, even when the drum 20 rotates in the first rotational direction or the second rotational direction, water and/or foreign substances can be easily introduced into the filter 100.

A washing machine 1 according to an embodiment of the disclosure may include: a housing 10; a drum 20 rotatably provided inside the housing 10; and a filter 100 couplable to the drum 20 and configured to filter out foreign substances, wherein the filter 100 may include a filter case 110 couplable to the drum 20, and a filter body 150 detachably mounted to the filter case 110 and having an inlet portion 163 and an outlet portion 167, wherein the filter body 150 may include a body protrusion 172 protruding toward the filter case 110, and the filter case 110 may include a case protrusion 122 protruding toward the body protrusion 172 and a case groove 123 recessed into the case protrusion 122 and allowing the body protrusion 172 to be coupleable thereto. According to the present disclosure, separation of the filter body 150 from the filter case 110 can be prevented.

The filter body may further include a front filter body in which the inlet portion is formed thereon; and a rear filter body disposed between the front filter body and the filter case, wherein the body protrusion may be provided on the front filter body. According to the present disclosure, the front filter body 160 can be firmly coupled to the filter case 110.

The filter case 110 may further include a protruding rib 121 protruding toward the filter body 150 to prevent the filter body 150 from moving. According to the present disclosure, even when the drum 20 rotates, separation of the filter body 150 from the filter case 110 can be prevented.

The filter body 150 may include a first side portion 151 disposed to face a first rotational direction of the drum 20 and a second side portion 152 disposed to face a second rotational direction opposite to the first rotational direction of the drum 20, and the protruding rib 121 may include a first protruding rib 121a) configured to support the first side portion 151 of the filter body 150 in the second rotational direction and a second protruding rib 121b) configured to support the second side portion 152 of the filter body 150 in the first rotational direction. According to the present disclosure, the filter body 150 can be prevented from being displaced depending on the first or second rotational direction of the drum 20.

The filter body 150 may include a chamber (C) formed therein to collect foreign substances, and the protruding rib 121 may be disposed on the outer side of the filter body 150. According to the present disclosure, the protruding rib 121 can support the filter body 150 more firmly.

According to the disclosure, foreign substances contained in the water can be easily filtered and collected.

According to the disclosure, the water storage capacity of the washing machine can be improved.

According to the disclosure, the filter can be prevented from being separated from the drum.

The effects of the disclosure are not limited to the effects described above, and other effects that are not described will be clearly understood by those skilled in the art from the above detailed description.

Although the disclosure has been shown and described in relation to specific embodiments, it would be appreciated by those skilled in the art that changes and modifications may be made in these embodiments without departing from the principles and scope of the disclosure, the scope of which is defined in the claims and their equivalents.

1. A washing machine comprising:
a housing;
a drum rotatable inside the housing; and
a filter couplable to the drum,
wherein the filter comprises:
a filter body including a first side portion having a first inlet and a second side portion having a second inlet and disposed opposite to the first side portion; and
a filter case configured to be coupled to the filter body and including a first protruding rib configured to be coupleable to at least a portion of the first side portion and a second protruding rib configured to be coupleable to at least a portion of the second side portion,
wherein at least a portion of the first side portion is disposed on an inner side of the first protruding rib, and a remaining portion of the first side portion and the first protruding rib form an external appearance of the filter, and
at least a portion of the second side portion is disposed on an inner side of the second protruding rib, and a remaining portion of the second side portion and the second protruding rib form an external appearance of the filter.

2. The washing machine according to claim 1, wherein the filter body further comprises a chamber formed inside thereof to collect foreign substances, and the first protruding rib and the second protruding rib are disposed on an outer side of the filter body.

3. The washing machine according to claim 2, wherein the first side portion of the filter body includes an inner surface disposed to face the chamber and an outer surface disposed opposite to the inner surface, and
the first protruding rib is disposed to contact the outer surface of the first side portion.

4. The washing machine according to claim 1, wherein the filter body further comprises a body protrusion protruding toward the filter case, and
the filter case further comprises a case groove configured to be coupleable with the body protrusion.

5. The washing machine according to claim 4, wherein the filter case further comprises a case protrusion protruding toward the filter body, and
the case groove is formed to be recessed in the case protrusion.

6. The washing machine according to claim 4, wherein the body protrusion is a first body protrusion on the first side portion of the filter body and the filter body further includes a second body protrusion on the second side portion of the filter body, and
the case groove includes a first case groove configured to be coupleable with the first body protrusion and a second case groove configured to be coupleable with the second body protrusion.

7. The washing machine according to claim 4, wherein the case groove is disposed between the first protruding rib and the second protruding rib.

8. The washing machine according to claim 4, wherein the filter body further comprises:
a front filter body in which the first inlet and the second inlet are formed thereon; and
a rear filter body disposed between the front filter body and the filter case;
wherein the body protrusion is provided on the front filter body.

9. The washing machine according to claim 8, wherein the front filter body and the rear filter body are hinged-coupled to each other.

10. The washing machine according to claim 8, wherein the filter body comprises:
a front outlet formed to pass through the front filter body; and
a rear outlet formed to pass through the rear filter body and open in a direction opposite to the front outlet.

11. The washing machine according to claim 8, wherein the rear filter body includes a collection rib configured to collect foreign substances introduced into the filter body, the collection rib protruding toward the front filter body.

12. The washing machine according to claim 1, wherein the drum comprises:
a cylindrical portion having a cylindrical shape; and
a bowl portion coupleable to a lower portion of the cylindrical portion to form a bottom of the drum;
wherein the filter case is disposed spaced apart from the bowl portion.

13. The washing machine according to claim 12, wherein the drum further comprises an inner wall rib, spaced apart from the filter case, protruding from the cylindrical portion toward a rotation axis of the drum.

14. The washing machine according to claim 13, wherein the inner wall rib includes a first inner wall rib and a second inner wall rib spaced apart from the first inner wall rib.

15. The washing machine according to claim 1, wherein the first inlet comprises:
an outer inlet on an outer side of the filter body; and
an inner inlet configured to communicate with the outer inlet and provided on an inner side of the filter body,
wherein a size of the inner inlet is provided smaller than a size of the outer inlet.
